(19) United States
(12) Patent Application Publication
(10) Pub. No.: US 2025/0289472 A1
(43) Pub. Date: Sep. 18, 2025

(54) TRAILER VEHICLE PATH PLANNING METHOD, APPARATUS AND TRAILER VEHICLE

(71) Applicant: Anhui DeepWay Technology Co., Ltd., Hefei (CN)

(72) Inventors: Pengtao MA, Hefei (CN); Lei SUN, Hefei (CN); Shouyang WEI, Hefei (CN); Feng DING, Hefei (CN); Donghao ZHANG, Hefei (CN); Shan TIAN, Hefei (CN)

(21) Appl. No.: 18/900,972

(22) Filed: Sep. 30, 2024

(30) Foreign Application Priority Data
Mar. 12, 2024 (CN) 202410285557.8

(51) Int. Cl. B60W 60/00

(52) U.S. Cl. CPC B60W 60/0015; B60W 2300/14; B60W 2552/53; B60W 2720/22

(57) ABSTRACT

Provided is a path planning method for a trailer vehicle, including: obtaining first position information from a plurality of first points on a tractor to a rear axle center of the tractor, second position information from a plurality of second points on a trailer to the rear axle center of the tractor, a first distance from the rear axle center of the tractor to a center line of a target road, a curvature of the center line of the target road, and a target difference between a heading angle of the trailer and a heading angle of the tractor; constructing a first projection distance equation and a second projection distance equation, separately, based on at least three of the first position information, the first distance, the curvature, the second position information, and the target difference; and obtaining a target path planning result.

### CROSS-REFERENCE TO RELATED APPLICATIONS

This application claims priority to Chinese patent application No. 202410285557.8, filed on Mar. 12, 2024, the entire disclosure of which is incorporated herein by reference.

### TECHNICAL FIELD

The present disclosure belongs to the technical field of path planning for trailer vehicles, and more particularly, to a path planning method and apparatus for a trailer vehicle and a trailer vehicle.

### BACKGROUND

For unmanned vehicles or vehicles with blind spots during manual driving, it is desired to plan paths for the vehicles to avoid collisions with obstacles. In the related art, there are methods for path planning based on search, sampling, or optimization, but the conventional methods cannot be applied to path planning for trailer vehicles. In the process of path planning for obstacle avoidance, the accuracy of the planned path obtained by using these methods is relatively low and the vehicles are likely to collide with obstacles.

### SUMMARY

It is an object of the present disclosure to solve at least one of the technical problems existing in the related art. To this end, the present disclosure provides a path planning method and apparatus for a trailer vehicle and a trailer vehicle, capable of effectively constraining a projection distance between points on the trailer vehicle and a center line of a road, so as to obtain a target path planning result without collision with obstacles, such that the accuracy of the target path planning result obtained can be improved.

In a first aspect, the present disclosure provides a path planning method for a trailer vehicle. The trailer vehicle includes a tractor and a trailer. The trailer is connected to the tractor through a connector. The method includes:
obtaining first position information from a plurality of first points on the tractor to a rear axle center of the tractor, second position information from a plurality of second points on the trailer to the rear axle center of the tractor, a first distance from the rear axle center of the tractor to a center line of a target road, a curvature of the center line of the target road, and a target difference between a heading angle of the trailer and a heading angle of the tractor;
constructing a first projection distance equation and a second projection distance equation, separately, based on at least three of the first position information corresponding to a first target point of the plurality of first points, the first distance, the curvature, the second position information corresponding to a second target point of the plurality of second points, and the target difference, the projection distance equations being used to calculate a projection distance from the first target point and/or the second target point to the center line of the target road; and
obtaining a target path planning result based on the first projection distance equation, the second projection distance equation, and a vehicle path constraint condition.

With the path planning method for the trailer vehicle according to the embodiment of the present disclosure, by obtaining the target difference between the heading angle of the trailer and the heading angle of the tractor, a projection distance equation corresponding to cach point on the trailer is constructed. For the trailer vehicle, on the basis of the predicted path corresponding to the tractor, the predicted path corresponding to the trailer can also be obtained based on a heading deviation between the trailer and the tractor. In this way, the projection distance between the points on the tractor and the trailer and the center line of the road can be effectively constrained, thereby obtaining a target path planning result without collision with obstacles, and the target path planning result of the trailer and the tractor obtained has high accuracy.

In the path planning method for the trailer vehicle according to the present disclosure, the operation of constructing the second projection distance equation based on at least three of the first position information corresponding to the first target point of the plurality of first points, the first distance, the curvature, the second position information corresponding to the second target point of the plurality of second points, and the target difference may include:
determining a third distance between the rear axle center and the target second point and a fourth angle based on the second position information, the fourth angle being an angle determined based on a line connecting the second target point with the rear axle center and a heading direction of the trailer;
determining a second angle based on the heading angle of the tractor and a heading angle of the center line of the target road;
determining a fifth angle based on the fourth angle, the second angle, and the target difference, the fifth angle being an angle determined based on a line connecting a circle center of the center line of the target road with the rear axle center and a line connecting the rear axle center with the second target point; and
processing the first distance, the third distance, the fifth angle, and the curvature based on Law of Cosines to construct the second projection distance equation.

In the path planning method for the trailer vehicle according to the present disclosure, the operation of processing the first distance, the third distance, the fifth angle, and the curvature based on Law of Cosines to construct the second projection distance equation may include:
constructing the second projection distance equation according to the following equation when the curvature is greater than 0:

$${e}_{{C}_{i , tra}} = - \sqrt{{d}_{i , tra}^{2} + {( {e}_{y} - \frac{1}{{κ}_{r} ( s )} )}^{2} + 2 {d}_{i . tra} ( {e}_{y} - \frac{1}{{κ}_{r} ( s )} ) sin ( {e}_{φ} + β + {θ}_{i , tra} )} + \frac{1}{{κ}_{r} ( s )}$$

where e_{C}_{_{i,tra}} is a second projection distance, d_{i,tra} is the third distance, e_{y} is the first distance, κᵣ(s) is the curvature, θ_{i,tra} is the fourth angle, e_{φ} is the second angle, β is the target difference, and sin(e_{φ}+β+θ_{i,tra}) is obtained by processing the fifth angle based on Law of Cosines, or
constructing the second projection distance equation according to the following equation when the curvature is smaller than 0:

$${e}_{{C}_{i , tra}} = \sqrt{{d}_{i , tra}^{2} + {( {e}_{y} - \frac{1}{{κ}_{r} ( s )} )}^{2} + 2 {d}_{i . tra} ( {e}_{y} - \frac{1}{{κ}_{r} ( s )} ) sin ( {e}_{φ} + β + {θ}_{i , tra} )} + \frac{1}{{κ}_{r} ( s )}$$

where e_{C}_{_{i,tra}} is a second projection distance, d_{i,tra} is the third distance, e_{y} is the first distance, κᵣ(s) is the curvature, θ_{i,tra} is the fourth angle, e_{φ} is the second angle, β is the target difference, and sin(e_{φ}+βθ_{i,tra}) is obtained by processing the fifth angle based on Law of Cosines.

In the path planning method for the trailer vehicle according to the present disclosure, the operation of obtaining the target path planning result based on the first projection distance equation, the second projection distance equation, and the vehicle path constraint condition may include:
performing linear processing on the first projection distance equation and the second projection distance equation to obtain a target projection distance equation; and
obtaining the target path planning result based on the target projection distance and the vehicle path constraint condition.

In the path planning method for the trailer vehicle according to the present disclosure, the target projection distance equation may include:

$${e}_{C} = {ξ}_{{e}_{y}} {e}_{y} + {ξ}_{{e}_{φ}} {e}_{φ} + {ξ}_{β} β + ξ = g ( x )$$

where g(x) and e_{C} are the target projection distance equations, e_{y} is the first distance, e_{φ} is a second angle determined based on the heading angle of the tractor and the heading angle of the center line of the target road, β is the target difference, ξₑ_{_{y}}, ξₑ_{_{φ}}, ξ_{β} and ξ are coefficients obtained by Taylor expansion of the first projection distance equation and the second projection distance equation.

In the path planning method for the trailer vehicle according to the present disclosure, the operation of constructing the first projection distance equation based on at least three of the first position information corresponding to the first target point of the plurality of first points, the first distance, the curvature, the second position information corresponding to the second target point of the plurality of second points, and the target difference may include:
determining a second angle based on the heading angle of the tractor and a heading angle of the center line of the target road; and
constructing the first projection distance equation based on the first distance, the first position information, the second angle, and the curvature.

In the path planning method for the trailer vehicle according to the present disclosure,
the operation of obtaining the plurality of first points on the tractor may include:
extracting the plurality of first points from an edge contour of the tractor according to a size of the tractor based on a target step size, and
the operation of obtaining the plurality of second points on the trailer may include:
extracting the plurality of second points from the edge contour of the trailer according to a size of the trailer based on a target step size.

In a second aspect, the present disclosure provides a path planning apparatus for a trailer vehicle. The trailer vehicle includes a tractor and a trailer, and the trailer is connected to the tractor through a connector. The apparatus includes:
a first processing module configured to obtain first position information from a plurality of first points on the tractor to a rear axle center of the tractor, second position information from a plurality of second points on the trailer to the rear axle center of the tractor, a first distance from the rear axle center of the tractor to a center line of a target road, a curvature of the center line of the target road, and a target difference between a heading angle of the trailer and a heading angle of the tractor;
a second processing module configured to construct a first projection distance equation and a second projection distance equation, separately, based on at least three of the first position information corresponding to a first target point of the plurality of first points, the first distance, the curvature, the second position information corresponding to a second target point of the plurality of second points, and the target difference, the projection distance equations being used to calculate a projection distance from the first target point and/or the second target point to the center line of the target road; and
a third processing module configured to obtain a target path planning result based on the first projection distance equation, the second projection distance equation, and a vehicle path constraint condition.

With the path planning apparatus for the trailer vehicle according to the embodiment of the present disclosure, by obtaining the target difference between the heading angle of the trailer and the heading angle of the tractor, a projection distance equation corresponding to each point on the trailer is constructed. For the trailer vehicle, on the basis of the predicted path corresponding to the tractor, the predicted path corresponding to the trailer can also be obtained based on a heading deviation between the trailer and the tractor. In this way, the projection distance between the points on the tractor and the trailer and the center line of the road can be effectively constrained, thereby obtaining a target path planning result without collision with obstacles, and the target path planning result of the trailer and the tractor obtained has high accuracy.

In a third aspect, the present disclosure provides a trailer vehicle. The trailer vehicle includes a tractor and a trailer, and the trailer is connected to the tractor through a connector. The trailer vehicle is configured to operate based on the path planning method for the trailer vehicle according to the first aspect.

In a fourth aspect, the present disclosure provides an electronic device. The electronic device includes a memory, a processor, and a computer program stored in the memory and executable on the processor. The processor is configured to implement, when executing the computer program, the path planning method for the trailer vehicle according to the first aspect.

In a fifth aspect, the present disclosure provides a non-transitory computer-readable storage medium. The non-transitory computer-readable storage medium has a computer program stored thereon. The computer program, when executed by a processor, implements the path planning method for the trailer vehicle according to the first aspect.

In a sixth aspect, the present disclosure provides a computer program product. The computer program product includes a computer program. The computer program, when executed by a processor, implements the path planning method for the trailer vehicle according to the first aspect.

The above one or more technical solutions in the embodiments of the present disclosure have at least one of the following technical effects:

By obtaining the target difference between the heading angle of the trailer and the heading angle of the tractor, a projection distance equation corresponding to each point on the trailer is constructed. For the trailer vehicle, on the basis of the predicted path corresponding to the tractor, the predicted path corresponding to the trailer can also be obtained based on a heading deviation between the trailer and the tractor. In this way, the projection distance between the points on the tractor and the trailer and the center line of the road can be effectively constrained, thereby obtaining a target path planning result without collision with obstacles, and the obtained target path planning result of the trailer and the tractor has high accuracy.

Further, by linearly processing the first projection distance equation and the second projection distance equation, the target projection distance equation can be obtained, and the path planning optimization problem can be constructed. The linear target projection distance equation is used as a constraint condition of the path planning problem, which improves the speed of obtaining the target path planning result, thereby improving the efficiency of path planning and meeting the requirements of real-time path optimization during autonomous driving.

Furthermore, by taking into account the sizes of the tractor and the trailer, a plurality of first points are extracted on the edge contour of the tractor, and a plurality of second points are extracted on the edge contour of the trailer, based on the target step size. Subsequently, path planning can be performed according to the size of the vehicle, thereby improving the accuracy of path planning.

Additional aspects and advantages of the present disclosure will be at least partially given in the following description, and at least partially will become apparent from the following description, or will be understood through practice of the present disclosure.

### BRIEF DESCRIPTION OF DRAWINGS

The above and/or additional aspects and advantages of the present disclosure will become apparent and easy to understand from the description of the embodiments in combination with the following figures, in which:

FIG. 1 is a flowchart illustrating a path planning method for a trailer vehicle according to an embodiment of the present disclosure;

FIG. 2 is a first schematic diagram showing a principle of a path planning method for a trailer vehicle according to an embodiment of the present disclosure;

FIG. 3 is a second schematic diagram showing a principle of a path planning method for a trailer vehicle according to an embodiment of the present disclosure;

FIG. 4 is a schematic diagram showing a structure of a path planning apparatus for a trailer vehicle according to an embodiment of the present disclosure; and

FIG. 5 is a schematic diagram showing a structure of an electronic device according to an embodiment of the present disclosure.

### DESCRIPTION OF EMBODIMENTS

The technical solutions in the embodiments of the present disclosure will be described clearly and completely below with reference to the figure in the embodiments of the present disclosure. Obviously, the described embodiments are only some embodiments, rather than all embodiments, of the present disclosure. All other embodiments obtained by those skilled in the art based on the embodiments in the present disclosure without inventive efforts are to be encompassed by the scope of the present disclosure.

It is to be noted that the terms “first” and “second” in the description and claims of the present disclosure and the above-mentioned figures are used to distinguish similar objects from each other, and are not necessarily used to describe a specific sequence or order. It should be understood that the data used in this way can be interchanged as appropriate such that the embodiments of the present disclosure can be implemented in orders other than those shown or described herein. The objects distinguished using “first”, “second”, etc. are typically of the same type, and the number of objects is not limited. For example, the first object can be one or more. In addition, “and/or” as used in the description and claims means at least one of the connected objects, and the character “/” generally means that the related objects are in an “or” relationship.

With reference to the accompanying drawings, a path planning method for a trailer vehicle, a path planning apparatus for a trailer vehicle, an electronic device, and a readable storage medium according to the embodiments of the present disclosure will be described in detail with specific embodiments and their application scenarios.

Here, the path planning method for the trailer vehicle can be applied to a terminal, and in particular, can be executed by hardware or software in the terminal.

The terminal may include, but not limited to, a portable communication device such as a mobile phone or a tablet computer having a touch-sensitive surface (e.g., a touch screen display and/or a touch pad). It can be appreciated that in some embodiments, the terminal may not be a portable communication device, but a desktop computer having a touch-sensitive surface (e.g., a touch screen display and/or a touch pad).

In the following embodiments, a terminal including a display and a touch-sensitive surface is described. However, it can be appreciated that the terminal may include one or more other physical user interface devices such as a physical keyboard, a mouse, and a joystick.

The path planning method for the trailer vehicle according to the embodiment of the present disclosure may be performed by a trailer vehicle, an electronic device that is communicatively connected to the trailer vehicle, or a functional module or functional entity in the trailer vehicle or the electronic device that can implement the path planning method for the trailer vehicle. The electronic device as described in the embodiment of the present disclosure may include, but not limited to, a mobile phone, a tablet computer, a computer, a camera, and a wearable device. The path planning method for the trailer vehicle according to the embodiment of the present disclosure will be described below with reference to an example where the method is performed by an electronic device.

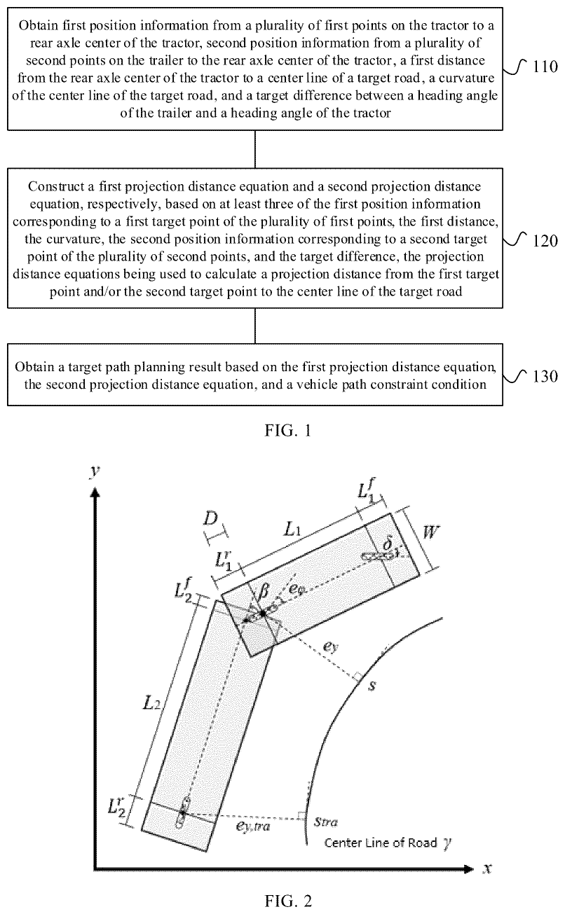

As shown in FIG. 1, the path planning method for the trailer vehicle includes: Step 110, Step 120, and Step 130.

It should be noted that, in some embodiments, the trailer vehicle may be a trailer vehicle such as a truck or a semi-trailer.

The trailer vehicle may include a tractor and a trailer.

The trailer is connected to the tractor through a connector, and the connector may be a hinge.

A hinge point may be provided on the tractor, and the trailer may be connected to the hinge point.

As shown in FIG. 2, the distance from the hinge point to a rear axle center of the tractor is D, and the value of D is much smaller than the size of the tractor and the size of the trailer. In the present disclosure, during the process of path planning, D can be regarded as 0, and then the path planning is performed to simplify the calculation.

It can be appreciated that the sizes of the tractor and the trailer are much larger than that of a passenger car.

During the moving process, the moving trajectories of the tractor and the trailer may be different.

At Step 110, first position information from a plurality of first points on the tractor to a rear axle center of the tractor, second position information from a plurality of second points on the trailer to the rear axle center of the tractor, a first distance from the rear axle center of the tractor to a center line of a target road, a curvature of the center line of the target road, and a target difference between a heading angle of the trailer and a heading angle of the tractor are obtained.

In this step, as shown in FIG. 2, the tractor is the vehicle head with driving capability located in the front of the semi-trailer.

The trailer is the vehicle without tractive driving capability located in the rear of the semi-trailer.

The rear axle center of the tractor can be located on the center line of the rear wheels of the tractor, that is, the center point of the rear of the vehicle, as shown by point T in FIG. 3.

The first point is a point on an edge contour of the tractor.

In practical applications, a plurality of first points on the edge contour of the tractor can be obtained.

For example, the plurality of first points on the edge contour of the tractor can be uniformly obtained; or different numbers of first points located at different positions can be obtained based on a moving direction of the tractor.

For example, when the tractor is moving to the left, a first number of first points on the left side contour of the tractor and a second number of first points on the right side contour can be obtained.

Alternatively, the plurality of first points can be obtained using other methods, which can be selected based on user needs, and the present disclosure is not limited to this.

In some embodiments, the operation of obtaining the plurality of first points on the tractor may include:

extracting the plurality of first points from an edge contour of the tractor according to a size of the tractor based on a target step size.

In this embodiment, the target step size is a predetermined distance.

The distance between any two adjacent first points in the plurality of first points is the target step size.

The actual length of the target step size can be 10 cm, or can be 0.2 m, or can be other values, which can be determined based on the sizes of the tractor and the trailer, and the present disclosure is not limited to this.

For example, when the target step size is 10 cm, a target number of first points can be uniformly extracted on the edge contour of the tractor at intervals of 10 cm.

The size of the tractor may include a wheelbase, a front overhang length, a rear overhang length, and a vehicle width of the tractor.

Here, the wheelbase is the length between the front axle and the rear axle of the tractor.

As shown in FIG. 2, L₁ is the wheelbase of the tractor, L₁^{f} is the front overhang length of the tractor, L₁^{r} is the rear overhang length of the tractor, and W is the vehicle width of the tractor.

The second point is a point on the edge contour of the trailer.

In practical applications, a plurality of second points on the edge contour of the trailer can be obtained.

The plurality of second points on the edge contour of the trailer can be uniformly obtained.

In some embodiments, the operation of obtaining the plurality of second points on the trailer may include:
extracting the plurality of second points from the edge contour of the trailer according to a size of the trailer based on a target step size.

In this embodiment, the size of the trailer may include a wheelbase, a front overhang length, a rear overhang length, and a vehicle width of the trailer.

As shown in FIG. 2, L₂ is the wheelbase of the trailer, L₂^{f} is the front overhang length of the trailer, L₂^{r} is the rear overhang length of the trailer, and W is the vehicle width of the trailer.

During the research and development process, the inventors found that there is a method in the related art that simplifies the vehicle model into a mass point model to perform path planning for the trailer vehicle. This method ignores the size constraints of the vehicle, and the calculated planning path has low accuracy.

According to the path planning method for the trailer vehicle according to the embodiment of the present disclosure, by taking into account the sizes of the tractor and the trailer, a plurality of first points are extracted on the edge contour of the tractor, and a plurality of second points are extracted on the edge contour of the trailer based on the target step size. Subsequently, the path planning can be performed according to the size of the vehicle, thereby improving the accuracy of path planning.

The first position information represents the distance from each of the first points to the rear axle center of the tractor.

The distance may include a lateral distance and a longitudinal distance.

The second position information represents the distance from each of the second points to the rear axle center of the tractor.

The center line of the target road is the center line of the road on which the vehicle is moving, as shown by the road center line “γ” in FIG. 3.

It can be appreciated that on a structured road, the curvature of the road will not change dramatically, so the road can be approximated as an equal-curvature circle at the rear axle center of the tractor, that is, the center line of the target road, as shown in FIG. 3(a), where O is the circle center of the center line of the target road.

The curvature of the center line of the target road represents the degree of curvature of the center line of the target road.

The degree of curvature of the center line of the target road may increase as the absolute value of the curvature increases.

In the case where the curvature directions of the center line of the target road are different, the curvature may be positive or negative.

FIG. 3 shows a top view model of the positional relationship between the tractor, the trailer, and the center line of the target road. In the same coordinate system, when the curvature is greater than 0, the center line of the target road is shown in FIG. 3(a); and when the curvature is smaller than 0, the center line of the target road is shown in FIG. 3(b).

The first distance is the distance from the rear axle center of the tractor to the center line of the road, as shown by e_{y} in FIG. 3.

The heading angle of the tractor can represent the current moving direction of the tractor.

The heading angle of the trailer can represent the current moving direction of the trailer.

The heading angle can be an angle between the moving direction of the vehicle and the geographic East direction.

In the autonomous driving system, the heading angles of the tractor and trailer can be detected and measured by sensors (such as gyroscopes or vehicle inertial measurement unit).

The target difference is a difference between the heading angle of the trailer and the heading angle of the tractor.

The target difference can represent the deviation between the moving direction of the trailer and the moving direction of the tractor. For example, at current time, when the moving direction of the trailer is consistent with the moving direction of the tractor, the target difference may be 0. As shown in FIG. 2, when the moving direction of the trailer is inconsistent with the moving direction of the tractor, the target difference may be β.

Here, the target difference may be expressed as: β=θₜᵣₐᵢₗₑᵣ−θ_{tractor}, where θₜᵣₐᵢₗₑᵣ is the heading angle of the trailer, and θ_{tractor} is the heading angle of the tractor.

At Step 120, a first projection distance equation and a second projection distance equation are constructed, separately, based on at least three of the first position information corresponding to a first target point of the plurality of first points, the first distance, the curvature, the second position information corresponding to a second target point of the plurality of second points, and the target difference. The projection distance equations are used to calculate a projection distance from the first target point and/or the second target point to the center line of the target road.

In this step, the first target point may be any point of the plurality of first points.

The second target point may be any point of the plurality of second points.

The first projection distance equation is used to calculate a first projection distance from the first target point to the center line of the target road.

The second projection distance equation is used to calculate a second projection distance from the second target point to the center line of the target road.

Here, the first projection distance is a straight-line distance between the first target point and a projection point of the first target point on the center line of the target road.

The second projection distance is a straight-line distance between the second target point and a projection point of the second target point on the center line of the target road.

By constraining the projection distance equations, collisions between the vehicle and obstacles in the road can be effectively avoided, or the vehicle can avoid moving across the center line of the road.

In the actual implementation process, the first projection distance equation corresponding to the tractor and the second projection distance equation corresponding to the trailer can be constructed based on at least three of the first position information, the first distance, the curvature, the second position information, and the target difference.

For example, the first projection distance equation can be constructed based on the first position information, the first distance, and the curvature.

The second projection distance equation can be constructed based on the second position information, the first distance, the curvature, and the target difference.

At Step 130, a target path planning result is obtained based on the first projection distance equation, the second projection distance equation, and a vehicle path constraint condition.

In this step, the target path planning result may be an optimal path for the vehicle to move.

For example, the optimal path can be a path with a minimum error between the path and the reference line and allowing accurate obstacle avoidance.

The target path planning result can include the path planning result corresponding to the tractor and the path planning result corresponding to the trailer.

The vehicle path constraint condition is used to constrain the vehicle within a collision-free safety range.

The vehicle path constraint condition can include a constraint condition that constrains the vehicle within a collision-free range, and a constraint condition for planning the path of the vehicle, such as constraints on the vehicle's moving curvature, starting point, and end point.

The vehicle's moving path is constrained by the vehicle path constraint condition, such that the requirements for collision-free between the vehicle and obstacles and for path planning for the vehicle can be met.

In the actual implementation process, the target path planning result for the next prediction step can be obtained based on the current moving state of the vehicle.

Within the next prediction step, the vehicle can move based on the target path planning result.

With the path planning method for the trailer vehicle according to the embodiment of the present disclosure, by obtaining the target difference between the heading angle of the trailer and the heading angle of the tractor, a projection distance equation corresponding to each point on the trailer is constructed. For the trailer vehicle, on the basis of the predicted path corresponding to the tractor, the predicted path corresponding to the trailer can also be obtained based on a heading deviation between the trailer and the tractor. In this way, the projection distance between the points on the tractor and the trailer and the center line of the road can be effectively constrained, thereby obtaining a target path planning result without collision with obstacles, and the target path planning result of the trailer and the tractor obtained has high accuracy.

In some embodiments, the operation of constructing the first projection distance equation based on the first position information corresponding to the first target point of the plurality of first points, the first distance, and the curvature may include:
determining a second angle based on the heading angle of the tractor and a heading angle of the center line of the target road; and
constructing the first projection distance equation based on the first distance, the first position information, the second angle, and the curvature.

In some embodiments, the operation of constructing the first projection distance equation based on the first distance, the first position information, the second angle, and the curvature may include:
determining a second distance and a first angle between the rear axle center and the first target point based on the first position information, the first angle being an angle determined based on a line connecting the first target point with the rear axle center and a heading direction of the tractor;
determining a third angle based on the first angle and the second angle, the third angle being an angle determined based on a line connecting a circle center of the center line of the target road with the rear axle center and a line connecting the rear axle center with the first target point; and
processing the first distance, the second distance, the third angle, and the curvature based on Law of Cosines to construct the first projection distance equation.

In this embodiment, referring to FIG. 3(a), the second distance is the shortest distance |TCᵢ| between the rear axle center T and the first target point Cᵢ.

The first angle is the angle between the line TCᵢ between the first target point and the rear axle center and the heading direction of the tractor, as shown by the angle θᵢ in FIG. 3(a).

In some embodiments, the first position information may include: a lateral distance from the first target point to the rear axle center and a longitudinal distance from the first target point to the rear axle center.

As shown in FIG. 3, the lateral distance is the length between point Cᵢ and point T along the shorter side of the tractor, as shown by W_{C}_{ᵢ} in FIG. 3, and the longitudinal distance is the length between point Cᵢ and point T along the longer side of the tractor, as shown by L_{C}_{ᵢ} in FIG. 3.

With the path planning method for the trailer vehicle according to the embodiment of the present disclosure, the lateral distance from the first target point to the rear axle center and the longitudinal distance from the first target point to the rear axle center are effectively determined based on the positional relationship between the first target point and the rear axle center, so as to provide data for the subsequent calculation of the projection distance, thereby improving the accuracy of the calculation.

In the actual implementation process, the first angle can be determined according to:

$${θ}_{i} = arctan ( \frac{{W}_{{C}_{i}}}{{L}_{{C}_{i}}} )$$

where θᵢ is the first angle, W_{C}_{ᵢ} is the lateral distance from the first target point to the rear axle center, and L_{C}_{ᵢ} is the longitudinal distance from the first target point to the rear axle center.

The second distance can be determined according to:

$${d}_{i} = sign ( {L}_{{C}_{i}} ) \sqrt{{W}_{{C}_{i}}^{2} + {L}_{{C}_{i}}^{2}}$$

where dᵢ is the second distance, W_{C}_{ᵢ} is the lateral distance from the first target point to the rear axle center, and L_{C}_{ᵢ} is the longitudinal distance from the first target point to the rear axle center.

Continuing to refer to FIG. 3(a), the second angle is the difference between the heading angle of the tractor and the heading angle of the center line of the target road. The second angle can be expressed as e_{φ}.

The second angle can be determined according to:

$${e}_{φ} = {θ}_{tractor} - {θ}_{γ}$$

where e_{φ} is the second angle, θ_{tractor} is the heading angle of the tractor, and θ_{γ} is the heading angle of the center line of the target road.

The third angle is an angle determined based on a line connecting the circle center of the center line of the target road with the rear axle center and a line connecting the rear axle center with the first target point.

Continuing to refer to FIG. 3(a), the third angle can be expressed as ∠OTCᵢ.

In the actual implementation process, when the curvature is greater than 0, the third angle can be determined according to:

$$∠ {OTC}_{i} = π - π / 2 + {e}_{φ} + {θ}_{i} = π / 2 + {e}_{φ} + {θ}_{i}$$

where ∠OTCᵢ is the third angle, e_{φ} is the second angle, and θᵢ is the first angle.

It can be understood that each angle has a positive or negative sign.

In the actual implementation process, the first projection distance equation can be constructed based on the relationship between sides of a triangle formed by the first target point, the rear axle center, and the circle center.

Continuing to refer to FIG. 3(a), it can be appreciated that the triangle formed by the three positions of the first target point, the rear axle center and the circle center includes the line segment |OT|, the line segment |TCᵢ|, and the line segment |OCᵢ|.

Based on Law of Cosines, the following equation can be obtained:

$${\vert OT \vert}^{2} + {\vert {TC}_{i} \vert}^{2} - {\vert {OC}_{i} \vert}^{2} = 2 \times \vert OT \vert \times \vert {TC}_{i} \vert \times cos ( ∠ {OTC}_{i} )$$

where ∠OTCᵢ is the third angle.

In the actual implementation process, the first projection distance equation can be constructed based on the relationship between respective sides and the first distance, the second distance, the third angle, and the curvature in the equation determined based on Law of Cosines.

With the path planning for the trailer vehicle according to the embodiment of the present disclosure, the second distance and the first angle between the rear axle center and the first target point are determined by obtaining the first position information, the second angle is determined based on the heading angle of the tractor and the heading angle of the center line of the target road, the third angle is calculated based on the first angle and the second angle, and the obtained correlation between the first distance, the second distance, the third angle, and the curvature is processed based on Law of Cosines, so as to construct the first projection distance equation based on the correlation, provide data support for subsequent path planning, and plan the path for the vehicle based on the equation, thereby effectively improving the efficiency and completeness of path planning.

In some embodiments, the operation of processing the first distance, the second distance, the third angle, and the curvature based on Law of Cosines to construct the first projection distance equation may include:
constructing the first projection distance equation according to the following equation when the curvature is greater than 0:

$${e}_{i} = - \sqrt{{d}_{i}^{2} + {( {e}_{y} - \frac{1}{{κ}_{r} ( s )} )}^{2} + 2 {d}_{i} ( {e}_{y} - \frac{1}{{κ}_{r} ( s )} ) sin ( {e}_{φ} + {θ}_{i} )} + \frac{1}{{κ}_{r} ( s )}$$

where eᵢ is the first projection distance, dᵢ is the second distance, e_{y} is the first distance, κᵣ(s) is the curvature, θᵢ is the first angle, e_{φ} is the second angle, sin(e_{φ}+θᵢ) is obtained by processing the third angle based on Law of Cosines; or
constructing the first projection distance equation according to the following equation when the curvature is smaller than 0:

$${e}_{i} = \sqrt{{d}_{i}^{2} + {( {e}_{y} - \frac{1}{{κ}_{r} ( s )} )}^{2} + 2 {d}_{i} ( {e}_{y} - \frac{1}{{κ}_{r} ( s )} ) sin ( {e}_{φ} + {θ}_{i} )} + \frac{1}{{κ}_{r} ( s )}$$

where eᵢ is the first projection distance, dᵢ is the second distance, e_{y} is the first distance, κᵣ(s) is the curvature, θᵢ is the first angle, e_{φ} is the second angle, sin(e_{φ}+θᵢ) is obtained by processing the third angle based on Law of Cosines.

In this embodiment, the first distance, the second distance, the third angle and the curvature can be substituted into the equation |OT|²+|TCᵢ|²−|OCᵢ|²=2×|OT|×|TCᵢ|×cos(∠OTCᵢ) to obtain the first projection distance equation.

As shown in FIG. 3(a), when the curvature is greater than 0, the radius of the equal-curvature circle of the tractor at the rear axle center is

$$R = \frac{1}{{κ}_{r} ( s )} .$$

As shown in FIG. 3(b), when the curvature is smaller than 0, the radius of the equal-curvature circle of the tractor at the rear axle center is

$$R = - \frac{1}{{κ}_{r} ( s )} .$$

It can be understood that the first projection distance equation constructed when the curvature is greater than 0 is different from that constructed when the curvature is smaller than 0.

The first projection distance equation can be processed based on the vehicle path constraint condition to obtain optimal solutions of optimization variables in the first projection distance equation, such that the first projection distance can be constrained within a safe and collision-free range. Here the optimization variables include the first distance and the second angle, etc.

With the path planning method for the trailer vehicle according to the embodiment of the present disclosure, the first distance, the second distance, the third angle, and the curvature are processed based on Law of Cosines to effectively determine the first projection distance equation from the first target point to the center line of the target road. By taking into account the influence of the tractor size on the path planning, in the subsequent path planning process, the optimal control problem is constructed based on the projection distance equation as a constraint condition, so as to significantly improve the efficiency of path planning and save the time consumption for path planning.

In some embodiments, the operation of constructing the second projection distance equation based on the second position information corresponding to a second target point in the plurality of second points, the first distance, the curvature, and the target difference may include:
determining a third distance between the rear axle center and the second target point and a fourth angle based on the second position information, the fourth angle being an angle determined based on a line connecting the second target point with the rear axle center and a heading direction of the trailer;
determining a second angle based on the heading angle of the tractor and a heading angle of the center line of the target road;
determining a fifth angle based on the fourth angle, the second angle, and the target difference, the fifth angle being an angle determined based on a line connecting a circle center of the center line of the target road with the rear axle center and a line connecting the rear axle center with the second target point; and
processing the first distance, the third distance, the fifth angle, and the curvature based on Law of Cosines to construct the second projection distance equation.

In this embodiment, as shown in FIG. 3, the second target point can be represented as point C_{i,tra}, and the rear axle center of the tractor can be represented as point T.

The second position information may include: a lateral distance from the second target point to the rear axle center and a longitudinal distance from the second target point to the rear axle center.

As shown in FIG. 3, the lateral distance is the length between point C_{i,tra} and point T along the shorter side of the trailer, as shown by W_{C}_{_{i,tra}} in FIG. 3, and the longitudinal distance is the length between point C_{i,tra} and point T along the longer side of the trailer, as shown by L_{C}_{_{i,tra}} in FIG. 3.

In this embodiment, continuing to refer to FIG. 3 (a), the lateral distance from the second target point to the rear axle center can be expressed as W_{C}_{_{i,tra}}.

The longitudinal distance from the second target point to the rear axle center can be expressed as L_{C}_{_{i,tra}}.

The third distance is the length of the line segment connecting the second target point and the rear axle center.

The third distance can be represented as |TC_{i,tra}|,and the third distance can be represented as d_{i,tra}.

The third distance can be calculated according to:

$${d}_{i , tra} = sign ( {L}_{{C}_{i , tra}} ) \sqrt{{W}_{{C}_{i , tra}}^{2} + {L}_{{C}_{i , tra}}^{2}}$$

where d_{i,tra} is the third distance, W_{C}_{_{i,tra}} is the lateral distance from the second target point to the rear axle center, and L_{C}_{_{i,tra}} is the longitudinal distance from the second target point to the rear axle center.

The fourth angle is the angle between the line segment T_{C}_{_{i,tra}} and the heading direction of the trailer, as shown by θ_{i,tra} in FIG. 3.

The fourth angle can be calculated according to:

$${θ}_{i , tra} = arctan ( \frac{{W}_{{C}_{i , tra}}}{{L}_{{C}_{i , tra}}} )$$

where θ_{i,tra} is the fourth angle, W_{C}_{_{i,tra}} is the lateral distance from the second target point to the rear axle center, and L_{C}_{_{i,tra}} is the longitudinal distance from the second target point to the rear axle center.

The fifth angle is the angle between the line segment OT and the line segment T_{C}_{_{i,tra}}, as shown by ∠OTC_{i,tra} in FIG. 3.

When the curvature is greater than 0, the fifth angle can be determined according to:

$$∠ {OTC}_{i , tra} = π - π / 2 + ( {e}_{φ} + β ) + {θ}_{i , tra} = π / 2 + {e}_{φ} + β + {θ}_{i , tra}$$

where ∠OTC_{i,tra} is the fifth angle, e_{φ} is the second angle, θ_{i,tra} is the fourth angle, and β is the target difference.

It can be understood that each angle has a positive or negative sign.

The triangle formed by three positions of the second target point, the rear axle center, and the circle center includes the line segment |OT|, the line segment |TC_{i,tra}| and the line segment |OC_{i,tra}|.

Based on Law of Cosines, the following equation can be obtained:

$${\vert OT \vert}^{2} + {\vert {TC}_{i , tra} \vert}^{2} - {\vert {OC}_{i , tra} \vert}^{2} = 2 \times \vert OT \vert \times \vert {TC}_{i , tra} \vert \times cos ( ∠ {OTC}_{i , tra} )$$

where ∠OTC_{i,tra} is the fifth angle.

The second projection distance equation can be constructed based on the relationship between respective sides and the first distance, the third distance, the fifth angle, and the curvature in the equation determined based on Law of Cosines.

In some embodiments, the operation of processing the first distance, the third distance, the fifth angle, and the curvature based on Law of Cosines to construct the second projection distance equation may include:
constructing the second projection distance equation according to the following equation when the curvature is greater than 0:

$${e}_{{C}_{i , tra}} = - \sqrt{{d}_{i , tra}^{2} + {( {e}_{y} - \frac{1}{{κ}_{r} ( s )} )}^{2} + 2 {d}_{i , tra} ( {e}_{y} - \frac{1}{{κ}_{r} ( s )} ) sin ( {e}_{φ} + β + {θ}_{i , tra} )} + \frac{1}{{κ}_{r} ( s )} ,$$

where e_{C}_{_{i,tra}} is a second projection distance, d_{i,tra} is the third distance, e_{y} is the first distance, κᵣ(s) is the curvature, θ_{i,tra} is the fourth angle, e_{φ} is the second angle, β is the target difference, and sin(e_{φ}+β+θ_{i,tra}) is obtained by processing the fifth angle based on Law of Cosines, or
constructing the second projection distance equation according to the following equation when the curvature is smaller than 0:

$${e}_{{C}_{i , tra}} = \sqrt{{d}_{i , tra}^{2} + {( {e}_{y} - \frac{1}{{κ}_{r} ( s )} )}^{2} + 2 {d}_{i , tra} ( {e}_{y} - \frac{1}{{κ}_{r} ( s )} ) sin ( {e}_{φ} + β + {θ}_{i , tra} )} + \frac{1}{{κ}_{r} ( s )}$$

where e_{C}_{_{i,tra}} is a second projection distance, d_{i,tra} is the third distance, e_{y} is the first distance, κᵣ(s) is the curvature, θ_{i,tra} is the fourth angle, e_{φ} is the second angle, β is the target difference, and sin(e_{φ}+β+θ_{i,tra}) is obtained by processing the fifth angle based on Law of Cosines.

In this embodiment, the first distance, the third distance, the fifth angle and the curvature can be substituted into the equation |OT|²+|TC_{i,tra}|²−|OC_{i,tra}|²=2×|OT|×|TC_{i,tra}|×cos(∠OTC_{i,tra}) to obtain the second projection distance equation.

As shown in FIG. 3(a), when the curvature is greater than 0, the radius of the equal-curvature circle of the tractor at the rear axle center is

$$R = \frac{1}{{κ}_{r} ( s )} .$$

As shown in FIG. 3(b), when the curvature is smaller than 0, the radius of the equal-curvature circle of the tractor at the rear axle center is

$$R = - \frac{1}{{κ}_{r} ( s )} .$$

It can be understood that the second projection distance equation constructed when the curvature is greater than 0 is different from that when the curvature is smaller than 0.

The second projection distance equation can be processed based on the vehicle path constraint condition to obtain optimal solutions of optimization variables in the second projection distance equation, and then the second projection distance can be constrained within a safe and collision-free range. Here the optimization variables include the first distance and the second angle, etc.

With the path planning method for the trailer vehicle according to the embodiment of the present disclosure, the first distance, the third distance, the fifth angle, and the curvature are processed based on Law of Cosines to effectively determine the second projection distance equation from the second target point to the center line of the target road. By taking into account the influence of the trailer size on the path planning, in the subsequent path planning process, the optimal control problem is constructed based on the projection distance equation as a constraint condition, so as to significantly improve the efficiency of path planning and save the time consumption for path planning.

In some embodiments, Step 130 may further include:
performing linear processing on the first projection distance equation and the second projection distance equation to obtain a target projection distance equation; and
obtaining the target path planning result based on the target projection distance and the vehicle path constraint condition.

In this embodiment, the first projection distance equation and the second projection distance equation are both nonlinear.

The target projection distance equation is a linear equation.

In some embodiments, a general projection distance equation can be obtained based on the first projection distance equation and the second projection distance equation.

Linear processing can be performed on the projection distance equation to obtain the target projection distance equation.

The first projection distance equation and the second projection distance equation can be linearly processed based on Taylor expansion method, Jacobian matrix method or piecewise linearization method, or any other linearization method. The method can be selected based on user needs, and the present disclosure is not limited to this.

In the actual implementation process, after constraining the target projection distance equation to a collision-free area based on the vehicle path constraint condition, the path optimization problem can be abstracted into a quadratic planning problem or a model predictive control problem. That is, the path planning problem is constructed as an optimization problem, and the path planning problem is optimized based on an optimization function.

The optimization function can be determined according to:

$$J = {\sum }_{i = 1}^{N - 1} {( {x}_{i} )}^{2} + {\sum }_{i = 1}^{N - 1} {( {u}_{i} )}^{2}$$

where J is a cost function, N is a prediction time domain, i is the i-th prediction step, xᵢ=[e_{y,i}, e_{φ,i}, β_{,i}]^{T} is a state variable at the i-th prediction step, and uᵢ=[κᵢ] is a control variable at the i-th prediction step.

Here, the target path planning result can be solved by using numerical optimization technology.

In the actual implementation process, e_{C} can be used to represent the straight-line distance between any point on the vehicle (tractor and trailer) and the projection point of the point on the center line of the target road, that is, the general projection distance equation is:

e_{C}=g_{c}(e_{y}, e_{φ}, β)
where e_{C} is the projection distance, e_{y} is the first distance, e_{φ} is the second angle, and β is the target difference.

By linearizing the above equation using the Taylor expansion method, the target projection distance equation can be obtained as:

$${e}_{C} = {ξ}_{{e}_{y}} {e}_{y} + {ξ}_{{e}_{φ}} {e}_{φ} + {ξ}_{β} β + ξ = g ( x )$$

where e_{y} is the first distance, e_{φ} is the second angle, β is the target difference, ξₑ_{_{y}}, ξₑ_{_{φ}}, ξ_{β}, and ξ are the coefficients obtained by Taylor expansion of g_{c}(e_{y}, e_{φ}, β) at the equilibrium point.

In the present disclosure, by linearly processing the first projection distance equation and the second projection distance equation, the target projection distance equation is obtained, and the path planning optimization problem is constructed. The linear target projection distance equation is used as a constraint condition of the path planning problem, which improves the speed of obtaining the target path planning result, thereby improving the efficiency of path planning and meeting the requirements of real-time path optimization during autonomous driving.

In some embodiments, the operation of obtaining the target path planning result based on the target projection distance and the vehicle path constraint condition may include:
processing the target projection distance equation based on a collision constraint to obtain a path planning constraint; and
obtaining the target path planning result based on the path planning constraint and a target constraint condition.

In this embodiment, the collision constraint is a condition that constrains the projection distance to the collision-free area.

Based on the collision constraint, the variables in the target projection distance equation can be constrained to the collision-free area.

The path planning constraint is a constraint condition determined based on the collision-free area of the projection distance corresponding to the projection distance equation.

The path planning constraint is used to constrain path selection during the path planning process.

In the actual implementation process, the projection distance equation can be constrained to the collision-free area based on the collision constraint to obtain the safe range of the projection distance between the point and the center line of the road. The collision-free area obtained by applying the collision constraint to the projection distance equation is used as a constraint condition in path planning to plan the vehicle's moving path.

The target constraint condition may include: at least one of a vehicle kinematic constraint, a vehicle state constraint, and a vehicle curvature constraint.

The vehicle kinematic constraint is a motion restriction condition dependent on the physical and dynamic characteristics of the vehicle itself during the vehicle's motion.

The vehicle kinematic constraint may include a maximum acceleration, a maximum turning angle, and a minimum turning radius of the vehicle, etc. The vehicle kinematic constraint is used to restrict the moving trajectory and behavior of the vehicle under specific conditions.

In some embodiments, the vehicle kinematic constraint can be determined based on the following steps:
determining a state vector and a control vector based on a kinematic model of the target vehicle in a curvilinear coordinate system;
linearizing and discretizing the kinematic model based on the state vector and the control vector to obtain a state space equation; and
determining the state space equation as the vehicle kinematic constraint.

In this embodiment, the kinematic model can be determined according to:

$${e}_{y}^{′} = ( 1 - {e}_{y} {κ}_{r} ) tan ( {e}_{φ} )$$

$${e}_{φ}^{′} = \frac{1 - {e}_{y} {κ}_{r}}{cos ( {e}_{φ} )} κ - {κ}_{r}$$

$${β}^{′} = \frac{1 - {e}_{y} {κ}_{r}}{cos ( {e}_{φ} )} ( - \frac{sin ( β )}{{L}_{2}} - \frac{D κcos ( β )}{{L}_{2}} - κ )$$

where e′_{y} is the differential of the displacement of the state quantity e_{y} in the curvilinear coordinate system; e′_{φ} is the differential of the displacement of the state quantity e_{φ} in the curvilinear coordinate system; β′ is the differential of the displacement of the state quantity β in the curvilinear coordinate system; e_{y} is the first distance; e_{φ} is the second angle; κ is the curvature of the tractor; κᵣ is the curvature of the center line of the target road; L₂ is the wheelbase of the trailer; and β is the target difference.

Here, the curvature of the tractor can be determined according to: κ=tan(δ)/L₁, where L₁ is the wheelbase of the tractor; and δ is the front wheel turning angle of the tractor.

The state vector is x=[e_{y}, e_{φ}, β]^{T}, where e_{y} is the first distance, e_{φ} is the second angle, and β is the target difference.

The control vector is u=[κ], where κ is the curvature of the tractor.

The state space equation is determined according to:

$${x}_{i + 1} = {A}_{i} {x}_{i} + {B}_{i} {u}_{i} + {D}_{i} , i ∈ \{ 0 , … , N - 2 \}$$

where Aᵢ is the system matrix; Bᵢ is the control matrix; Dᵢ is the disturbance matrix; and i is the i-th prediction time domain.

In the actual implementation process, the state space equation can be obtained based on the state vector and the control vector by using first-order Taylor expansion linearization and Euler equation discretization.

It can be appreciated that in the process of path planning for the vehicle, the path planning needs to meet the vehicle kinematic constraint, and the state space equation can be determined as the vehicle kinematic constraint.

In the present disclosure, the state vector and the control vector are determined based on the kinematic model of the vehicle in the curvilinear coordinate system, such that the kinematic model can be linearized and discretized based on the state vector and the control vector to obtain the state space equation. The state space equation is used as the vehicle kinematic constraint. The projection distance equation is solved based on the constraint, so as to perform path planning to obtain the target path planning result, thereby effectively improving the completeness and optimality of path planning.

The vehicle state constraint is the continuity and smoothness constraint that needs to be met in the path planning process.

The vehicle state constraint can be expressed as x₀=xₛₜₐᵣₜ, u₀=uₛₜₐᵣₜ, that is, the planning starting point must be consistent with the current state of the vehicle.

Here, x₀ is the state variable of the path planning starting point, xₛₜₐᵣₜ is the state variable of the vehicle at the current moment, u₀ is the control variable of the path planning starting point, and uₛₜₐᵣₜ is the control variable of the vehicle at the current moment.

The vehicle curvature constraint is the curvature that the vehicle's steering wheel angle can execute.

The vehicle curvature constraint can be expressed as:

$${u}_{min} \leq {u}_{i} \leq {u}_{max} , i ∈ \{ 1 , … , N - 1 \}$$

$$Δ {u}_{min} \leq {u}_{i} - {u}_{i - 1} \leq Δ {u}_{max} , i ∈ \{ 1 , … , N - 1 \}$$

where uₘᵢₙ is the minimum curvature that the vehicle can execute; uₘₐₓ is the maximum curvature that the vehicle can execute; Δuₘᵢₙ is the minimum curvature change rate that the vehicle can execute; Δuₘₐₓ is the maximum curvature change rate that the vehicle can execute; and uᵢ is the curvature of the vehicle at the i-th prediction step.

The collision constraint is the constraint required for the vehicle to not collide during the path planning process.

In some embodiments, the collision constraint can be determined based on the following steps:
limiting the first projection distance corresponding to each first target point and the second projection distance corresponding to each second target point to be within the target safety range to obtain the collision constraint.

In this embodiment, the target safety range is the range in which no collision occurs for each point of the vehicle.

The collision constraint can be expressed as l_{i,k}^{min}<e_{C,i,k}<l_{i,k}^{max},i∈{1, . . . , N−1}, k∈{1, . . . , M},
where k represents the k-th point of the plurality of first points and the plurality of second points; l_{i,k}^{min} is the minimum collision-free range of the k-th point at the i-th prediction step; and l_{i,k}^{max} is the maximum collision-free range of the k-th point at the i-th prediction step.

With the path planning method for the trailer vehicle according to the embodiment of the present disclosure, by limiting each point on the vehicle to be within the target safety range, the target vehicle's moving path is effectively planned within the safe area, thereby achieving accurate obstacle collision avoidance and improving the accuracy of path planning.

In the actual implementation process, the distance calculated based on the projection distance equation can be constrained within the collision-free area according to the predetermined target constraint condition, so as to obtain the target path planning result.

With the path planning method for the trailer vehicle according to the embodiment of the present disclosure, the projection distance equation is linearized, and the projection distance is constrained within the collision-free area based on one or more of the vehicle path constraint conditions (i.e., the vehicle kinematic constraint, the vehicle state constraint, the vehicle curvature constraint, and the collision constraint), such that the target path planning result can be obtained and the optimal path of the tractor and the trailer can be effectively determined. In the process of path planning, factors such as the size and motion state of the vehicle are taken into account, such that the accuracy of path planning can be effectively improved. Moreover, the path planning is performed based on multiple constraints, thereby saving a large amount of time consumed in a case where collision detection is performed after obtaining the path planning result and the detection result shows that a collision will occur and thus the path planning needs to be performed again.

A path planning apparatus for a trailer vehicle according to the present disclosure will be described below. The path planning apparatus for the trailer vehicle described below and the path planning method for the trailer vehicle described above can refer to each other.

The path planning method for the trailer vehicle according to the embodiment of the present disclosure can be performed by the path planning apparatus for the trailer vehicle. In the embodiment of the present disclosure, the path planning apparatus for the trailer vehicle according to the embodiment of the present disclosure will be described with reference to an example where the path planning method for the trailer vehicle is performed by the path planning apparatus for the trailer vehicle.

The embodiment of the present disclosure further provides a path planning apparatus for a trailer vehicle.

Here, the trailer vehicle includes a tractor and a trailer, and the trailer is connected to the tractor through a connector.

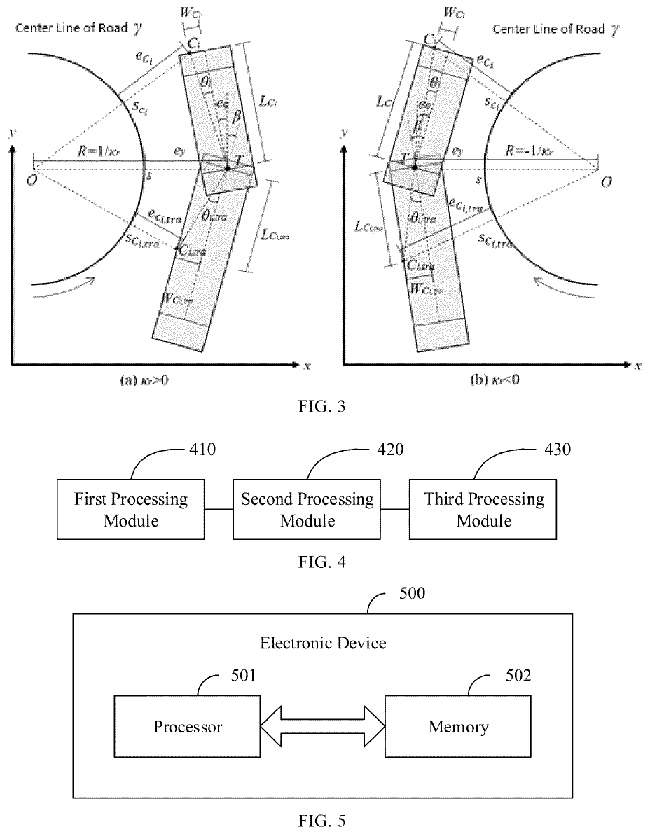

As shown in FIG. 4, the path planning apparatus for the trailer vehicle includes: a first processing module 410, a second processing module 420 and a third processing module 430.

The first processing module 410 is configured to obtain first position information from a plurality of first points on the tractor to a rear axle center of the tractor, second position information from a plurality of second points on the trailer to the rear axle center of the tractor, a first distance from the rear axle center of the tractor to a center line of a target road, a curvature of the center line of the target road, and a target difference between a heading angle of the trailer and a heading angle of the tractor.

The second processing module 420 is configured to construct a first projection distance equation and a second projection distance equation, separately, based on at least three of the first position information corresponding to a first target point of the plurality of first points, the first distance, the curvature, the second position information corresponding to a second target point of the plurality of second points, and the target difference, the projection distance equations being used to calculate a projection distance from the first target point and/or the second target point to the center line of the target road.

The third processing module 430 is configured to obtain a target path planning result based on the first projection distance equation, the second projection distance equation, and a vehicle path constraint condition.

With the path planning apparatus for the trailer vehicle according to the embodiment of the present disclosure, by obtaining the target difference between the heading angle of the trailer and the heading angle of the tractor, a projection distance equation corresponding to each point on the trailer is constructed. For the trailer vehicle, on the basis of the predicted path corresponding to the tractor, the predicted path corresponding to the trailer can also be obtained based on a heading deviation between the trailer and the tractor. In this way, the projection distance between the points on the tractor and the trailer and the center line of the road can be effectively constrained, thereby obtaining a target path planning result without collision with obstacles, and the target path planning result of the trailer and the tractor obtained has high accuracy.

In some embodiments, the second processing module 420 can be further configured to:
determine a third distance between the rear axle center and the second target point and a fourth angle based on the second position information, the fourth angle being an angle determined based on a line connecting the second target point with the rear axle center and a heading direction of the trailer;
determine a second angle based on the heading angle of the tractor and a heading angle of the center line of the target road;
determine a fifth angle based on the fourth angle, the second angle, and the target difference, the fifth angle being an angle determined based on a line connecting a circle center of the center line of the target road with the rear axle center and a line connecting the rear axle center with the second target point; and
process the first distance, the third distance, the fifth angle, and the curvature based on Law of Cosines to construct the second projection distance equation.

In some embodiments, the second processing module 420 can be further configured to:
construct the second projection distance equation according to the following equation when the curvature is greater than 0:

$${e}_{{C}_{i , tra}} = - \sqrt{{d}_{i , tra}^{2} + {( {e}_{y} - \frac{1}{{κ}_{r} ( s )} )}^{2} + 2 {d}_{i , tra} ( {e}_{y} - \frac{1}{{κ}_{r} ( s )} ) sin ( {e}_{φ} + β + {θ}_{i , tra} )} + \frac{1}{{κ}_{r} ( s )} ,$$

where e_{C}_{_{i,tra}} is a second projection distance, d_{i,tra} is the third distance, e_{y} is the first distance, κᵣ(s) is the curvature, θ_{i,tra} is the fourth angle, e_{φ} is the second angle, β is the target difference, and sin(e_{φ}+β+θ_{i,tra}) is obtained by processing the fifth angle based on Law of Cosines, or
construct the second projection distance equation according to the following equation when the curvature is smaller than 0:

$${e}_{{C}_{i , tra}} = \sqrt{{d}_{i , tra}^{2} + {( {e}_{y} - \frac{1}{{κ}_{r} ( s )} )}^{2} + 2 {d}_{i , tra} ( {e}_{y} - \frac{1}{{κ}_{r} ( s )} ) sin ( {e}_{φ} + β + {θ}_{i , tra} )} + \frac{1}{{κ}_{r} ( s )}$$

where e_{C}_{_{i,tra}} is a second projection distance, d_{i,tra} is the third distance, e_{y} is the first distance, κᵣ(s) is the curvature, θ_{i,tra} is the fourth angle, e_{φ} is the second angle, β is the target difference, and sin(e_{φ}+β+θ_{i,tra}) is obtained by processing the fifth angle based on Law of Cosines.

In some embodiments, the second processing module 420 can be further configured to:
determine a second angle based on the heading angle of the tractor and a heading angle of the center line of the target road; and
construct the first projection distance equation based on the first distance, the first position information, the second angle, and the curvature.

In some embodiments, the third processing module 430 can be further configured to:
perform linear processing on the first projection distance equation and the second projection distance equation to obtain a target projection distance equation; and
obtain the target path planning result based on the target projection distance and the vehicle path constraint condition.

In some embodiments, the third processing module 430 can be further configured to determine the target projection distance equation as:

$${e}_{C} = {ξ}_{{e}_{y}} {e}_{y} + {ξ}_{{e}_{φ}} {e}_{φ} + {ξ}_{β} β + ξ = g ( x )$$

where g(x) and e_{C} are the target projection distance equations, e_{y} is the first distance, e_{φ} is a second angle determined based on the heading angle of the tractor and the heading angle of the center line of the target road, β is the target difference, ξₑ_{_{y}}, ξₑ_{_{φ}}, ξ_{β} and ξ are coefficients obtained by Taylor expansion of the first projection distance equation and the second projection distance equation.

In some embodiments, the path planning apparatus for the trailer vehicle may further include a fourth processing module configured to:
extract the plurality of first points from an edge contour of the tractor according to a size of the tractor based on a target step size, and
extracting the plurality of second points from the edge contour of the trailer according to a size of the trailer based on a target step size.

The present disclosure further provides a trailer vehicle.

The trailer vehicle includes a tractor and a trailer, and the trailer is connected to the tractor through a connector.

The trailer vehicle may be a trailer vehicle such as a truck or a semi-trailer.

The trailer vehicle operates based on the path planning method for the trailer vehicle described in any of the above embodiments.

In some embodiments, the path planning apparatus for the trailer vehicle described in any of the above embodiments may be provided in the trailer vehicle.

With the trailer vehicle according to the embodiment of the present disclosure, by providing an apparatus for implementing the path planning method for the trailer vehicle described in any of the above embodiments in the trailer vehicle, it is possible to construct a projection distance equation corresponding to cach point based on a plurality of points on the tractor and the trailer, and use the equations as constraint conditions to effectively constrain the projection distances between the points on the vehicle and the center line of the road, thereby obtaining a target path planning result without collision with obstacles, and the accuracy of the obtained target path planning result can be high.

The path planning apparatus for the trailer vehicle in the embodiment of the present disclosure can be a trailer vehicle, or an electronic device communicatively connected to the vehicle, or a component in the trailer vehicle or the electronic device, such as an integrated circuit or a chip. The electronic device can be a terminal, or a device other than a terminal. Exemplarily, the electronic device may be a mobile phone, a tablet computer, a laptop computer, a palmtop computer, a vehicle-mounted electronic device, a Mobile Internet Device (MID), an Augmented Reality (AR)/Virtual Reality (VR) device, a robot, a wearable device, an Ultra-Mobile Personal Computer (UMPC), a netbook, or a Personal Digital Assistant (PDA), etc. It may also be a server, a Network Attached Storage (NAS), a Personal Computer (PC), a television (TV), a teller machine, or a self-service machine, etc. The embodiments of the present disclosure are not limited to any of these examples.

The path planning apparatus for the trailer vehicle in the embodiment of the present disclosure may be a device having an operating system. The operating system may be an Android operating system, an IOS operating system, or other possible operating systems. The embodiments of the present disclosure are not limited to any of these examples.

The path planning apparatus for the trailer vehicle according to the embodiment of the present disclosure can implement cach process implemented in the method embodiments of FIGS. 1 to 3, and details thereof will be omitted here for simplicity.

In some embodiments, as shown in FIG. 5, an embodiment of the present disclosure further provides an electronic device 500. The electronic device 500 includes a processor 501, a memory 502, and a computer program stored on the memory 502 and executable on the processor 501. The program, when executed by the processor 501, implements each process of the path planning method for the trailer vehicle in the above embodiment and can achieve the same technical effect. Details will be omitted here for simplicity.

It should be noted that the electronic device in the embodiment of the present disclosure includes the mobile electronic device and the non-mobile electronic device described above.

In another aspect, the present disclosure further provides a computer program product. The computer program product includes a computer program stored on a non-transitory computer-readable storage medium. The computer program includes program instructions. When the program instructions are executed by a computer, the computer can perform each process of the path planning method for the trailer vehicle in the above embodiment, and can achieve the same technical effect. Details will be omitted here for simplicity.

In another aspect, the present disclosure further provides a non-transitory computer-readable storage medium, having a computer program is stored thereon. The computer program, when is executed by the processor, implements each process of the path planning method for the trailer vehicle in the above embodiment, and can achieve the same technical effect. Details will be omitted here for simplicity.

In another aspect, an embodiment of the present disclosure further provides a chip. The chip includes a processor and a communication interface. The communication interface is coupled to the processor. The processor is configured to execute a program or instruction, to implement each process of the path planning method for the trailer vehicle in the above embodiment, and can achieve the same technical effect. Details will be omitted here for simplicity.

It can be appreciated that the chip in the embodiment of the present disclosure can also be called a system-level chip, a system chip, a chip system, or a system-on-chip chip, etc.

The apparatus embodiment described above is only illustrative. The units described as separate components may or may not be physically separated, and the components shown as units may or may not be physical units, that is, they may be located in one place, or may be distributed over a number of network units. Some or all of the modules can be selected according to actual needs to achieve the purpose of the solution of this embodiment. One skilled in the art can understand and implement it without creative efforts.

With the description of the above embodiments, one skilled in the art can clearly understand that each embodiment can be implemented by means of software plus a necessary general hardware platform, or of course, by hardware. Based on this understanding, the above technical solutions, in essence, or the part that makes contributions over the related art, can be embodied in the form of a software product, which can be stored in a computer-readable storage medium, such as ROM/RAM, a disk, an optical disk, etc., and includes a number of instructions for a computer device (which can be a personal computer, a server, or a network device, etc.) to implement the methods described in the respective embodiments or some parts of the embodiments.

Finally, it should be noted that the above embodiments are only used to illustrate, rather than limit, the technical solutions of the present disclosure. Although the present disclosure is described in detail with reference to the above embodiments, it can be appreciated by those skilled in the art that they can still modify the technical solutions disclosed in the above embodiments, or replace some of the technical features therein with equivalents, without departing from the spirit and scope of the technical solutions of the embodiments of the present disclosure.

What is claimed is:

1. A path planning method for a trailer vehicle, the trailer vehicle comprising a tractor and a trailer, and the trailer being connected to the tractor through a connector, the method comprising:
obtaining first position information from a plurality of first points on the tractor to a rear axle center of the tractor, second position information from a plurality of second points on the trailer to the rear axle center of the tractor, a first distance from the rear axle center of the tractor to a center line of a target road, a curvature of the center line of the target road, and a target difference between a heading angle of the trailer and a heading angle of the tractor;
constructing a first projection distance equation and a second projection distance equation, separately, based on at least three of the first position information corresponding to a first target point of the plurality of first points, the first distance, the curvature, the second position information corresponding to a second target point of the plurality of second points, and the target difference, the projection distance equations being used to calculate a projection distance from the first target point and/or the second target point to the center line of the target road; and
obtaining a target path planning result based on the first projection distance equation, the second projection distance equation, and a vehicle path constraint condition.

2. The method according to claim 1, wherein said constructing the second projection distance equation based on at least three of the first position information corresponding to the first target point of the plurality of first points, the first distance, the curvature, the second position information corresponding to the second target point of the plurality of second points, and the target difference comprises:
determining a third distance between the rear axle center and the target second point and a fourth angle based on the second position information, the fourth angle being an angle determined based on a line connecting the second target point with the rear axle center and a heading direction of the trailer;
determining a second angle based on the heading angle of the tractor and a heading angle of the center line of the target road;
determining a fifth angle based on the fourth angle, the second angle, and the target difference, the fifth angle being an angle determined based on a line connecting a circle center of the center line of the target road with the rear axle center and a line connecting the rear axle center with the second target point; and
processing the first distance, the third distance, the fifth angle, and the curvature based on Law of Cosines to construct the second projection distance equation.

3. The method according to claim 2, wherein said processing the first distance, the third distance, the fifth angle, and the curvature based on Law of Cosines to construct the second projection distance equation comprises:
constructing the second projection distance equation according to the following equation when the curvature is greater than 0:
$${e}_{{C}_{i , tra}} = - \sqrt{{d}_{i , tra}^{2} + {( {e}_{y} - \frac{1}{{κ}_{r} ( s )} )}^{2} + 2 {d}_{i , tra} ( {e}_{y} - \frac{1}{{κ}_{r} ( s )} ) sin ( {e}_{φ} + β + {θ}_{i , tra} )} + \frac{1}{{κ}_{r} ( s )} ,$$
where e_{C}_{_{i,tra}} is a second projection distance, d_{i,tra} is the third distance, e_{y} is the first distance, κᵣ(s) is the curvature, θ_{i,tra} is the fourth angle, e_{φ} is the second angle, β is the target difference, and sin(e_{φ}+β+θ_{i,tra}) is obtained by processing the fifth angle based on Law of Cosines, or
constructing the second projection distance equation according to the following equation when the curvature is smaller than 0:
$${e}_{{C}_{i , tra}} = - \sqrt{{d}_{i , tra}^{2} + {( {e}_{y} - \frac{1}{{κ}_{r} ( s )} )}^{2} + 2 {d}_{i , tra} ( {e}_{y} - \frac{1}{{κ}_{r} ( s )} ) sin ( {e}_{φ} + β + {θ}_{i , tra} )} + \frac{1}{{κ}_{r} ( s )}$$
where e_{C}_{_{i,tra}} is a second projection distance, d_{i,tra} is the third distance, e_{y} is the first distance, κᵣ(s) is the curvature, θ_{i,tra} is the fourth angle, e_{φ} is the second angle, β is the target difference, and sin(e_{φ}+β+θ_{i,tra}) is obtained by processing the fifth angle based on Law of Cosines.

4. The method according to claim 1, wherein said obtaining the target path planning result based on the first projection distance equation, the second projection distance equation, and the vehicle path constraint condition comprises:
performing linear processing on the first projection distance equation and the second projection distance equation to obtain a target projection distance equation; and
obtaining the target path planning result based on a target projection distance and the vehicle path constraint condition.

5. The method according to claim 4, wherein the target projection distance equation comprises:
$${e}_{C} = {ξ}_{{e}_{y}} {e}_{y} + {ξ}_{{e}_{φ}} {e}_{φ} + {ξ}_{β} β + ξ = g ( x )$$
where g(x) and e_{C} are the target projection distance equations, e_{y} is the first distance, e_{φ} is a second angle determined based on the heading angle of the tractor and the heading angle of the center line of the target road, β is the target difference, ξₑ_{_{y}}, ξₑ_{_{φ}}, ξ_{β} and ξ are coefficients obtained by Taylor expansion of the first projection distance equation and the second projection distance equation.

6. The method according to claim 1, wherein said constructing the first projection distance equation based on at least three of the first position information corresponding to the first target point of the plurality of first points, the first distance, the curvature, the second position information corresponding to the second target point of the plurality of second points, and the target difference comprises:
determining a second angle based on the heading angle of the tractor and a heading angle of the center line of the target road; and
constructing the first projection distance equation based on the first distance, the first position information, the second angle, and the curvature.

7. The method according to claim 1, wherein
said obtaining the plurality of first points on the tractor comprises:
extracting the plurality of first points from an edge contour of the tractor according to a size of the tractor based on a target step size, and
said obtaining the plurality of second points on the trailer comprises:
extracting the plurality of second points from the edge contour of the trailer according to a size of the trailer based on a target step size.

8. A path planning apparatus for a trailer vehicle, the trailer vehicle comprising a tractor and a trailer, and the trailer being connected to the tractor through a connector, the apparatus comprising:
a memory having a program instruction stored thereon; and
a processor configured to, when executing the program instruction, perform operations of:
obtaining first position information from a plurality of first points on the tractor to a rear axle center of the tractor, second position information from a plurality of second points on the trailer to the rear axle center of the tractor, a first distance from the rear axle center of the tractor to a center line of a target road, a curvature of the center line of the target road, and a target difference between a heading angle of the trailer and a heading angle of the tractor;
constructing a first projection distance equation and a second projection distance equation, separately, based on at least three of the first position information corresponding to a first target point of the plurality of first points, the first distance, the curvature, the second position information corresponding to a second target point of the plurality of second points, and the target difference, the projection distance equations being used to calculate a projection distance from the first target point and/or the second target point to the center line of the target road; and
obtaining a target path planning result based on the first projection distance equation, the second projection distance equation, and a vehicle path constraint condition.

9. The path planning apparatus according to claim 8, wherein said constructing the second projection distance equation based on at least three of the first position information corresponding to the first target point of the plurality of first points, the first distance, the curvature, the second position information corresponding to the second target point of the plurality of second points, and the target difference comprises:
determining a third distance between the rear axle center and the target second point and a fourth angle based on the second position information, the fourth angle being an angle determined based on a line connecting the second target point with the rear axle center and a heading direction of the trailer;
determining a second angle based on the heading angle of the tractor and a heading angle of the center line of the target road;
determining a fifth angle based on the fourth angle, the second angle, and the target difference, the fifth angle being an angle determined based on a line connecting a circle center of the center line of the target road with the rear axle center and a line connecting the rear axle center with the second target point; and
processing the first distance, the third distance, the fifth angle, and the curvature based on Law of Cosines to construct the second projection distance equation.

10. The path planning apparatus according to claim 9, wherein said processing the first distance, the third distance, the fifth angle, and the curvature based on Law of Cosines to construct the second projection distance equation comprises:
constructing the second projection distance equation according to the following equation when the curvature is greater than 0:
$${e}_{{C}_{i , tra}} = - \sqrt{{d}_{i , tra}^{2} + {( {e}_{y} - \frac{1}{{κ}_{r} ( s )} )}^{2} + 2 {d}_{i , tra} ( {e}_{y} - \frac{1}{{κ}_{r} ( s )} ) sin ( {e}_{φ} + β + {θ}_{i , tra} )} + \frac{1}{{κ}_{r} ( s )} ,$$
where e_{C}_{_{i,tra}} is a second projection distance, d_{i,tra} is the third distance, e_{y} is the first distance, κᵣ(s) is the curvature, θ_{i,tra} is the fourth angle, e_{φ} is the second angle, β is the target difference, and sin(e_{φ}+β+θ_{i,tra}) is obtained by processing the fifth angle based on Law of Cosines, or
constructing the second projection distance equation according to the following equation when the curvature is smaller than 0:
$${e}_{{C}_{i , tra}} = - \sqrt{{d}_{i , tra}^{2} + {( {e}_{y} - \frac{1}{{κ}_{r} ( s )} )}^{2} + 2 {d}_{i , tra} ( {e}_{y} - \frac{1}{{κ}_{r} ( s )} ) sin ( {e}_{φ} + β + {θ}_{i , tra} )} + \frac{1}{{κ}_{r} ( s )}$$
where e_{C}_{_{i,tra}} is a second projection distance, d_{i,tra} is the third distance, e_{y} is the first distance, κᵣ(s) is the curvature, θ_{i,tra} is the fourth angle, e_{φ} is the second angle, β is the target difference, and sin(e_{φ}+β+θ_{i,tra}) is obtained by processing the fifth angle based on Law of Cosines.

11. The path planning apparatus according to claim 8, wherein said obtaining the target path planning result based on the first projection distance equation, the second projection distance equation, and the vehicle path constraint condition comprises:
performing linear processing on the first projection distance equation and the second projection distance equation to obtain a target projection distance equation; and
obtaining the target path planning result based on a target projection distance and the vehicle path constraint condition.

12. The path planning apparatus according to claim 11, wherein the target projection distance equation comprises:
$${e}_{C} = {ξ}_{{e}_{y}} {e}_{y} + {ξ}_{{e}_{φ}} {e}_{φ} + {ξ}_{β} β + ξ = g ( x )$$
where g(x) and e_{C} are the target projection distance equations, e_{y} is the first distance, e_{φ} is a second angle determined based on the heading angle of the tractor and the heading angle of the center line of the target road, β is the target difference, ξₑ_{_{y}}, ξₑ_{_{φ}}, ξ_{β} and ξ are coefficients obtained by Taylor expansion of the first projection distance equation and the second projection distance equation.

13. The path planning apparatus according to claim 8, wherein said constructing the first projection distance equation based on at least three of the first position information corresponding to the first target point of the plurality of first points, the first distance, the curvature, the second position information corresponding to the second target point of the plurality of second points, and the target difference comprises:
determining a second angle based on the heading angle of the tractor and a heading angle of the center line of the target road; and
constructing the first projection distance equation based on the first distance, the first position information, the second angle, and the curvature.

14. The path planning apparatus according to claim 8, wherein
said obtaining the plurality of first points on the tractor comprises:
extracting the plurality of first points from an edge contour of the tractor according to a size of the tractor based on a target step size, and
said obtaining the plurality of second points on the trailer comprises:
extracting the plurality of second points from the edge contour of the trailer according to a size of the trailer based on a target step size.

15. A trailer vehicle, comprising a tractor, a trailer and the path planning apparatus according to claim 8, the trailer being connected to the tractor through a connector.

16. A non-transitory computer-readable storage medium, having a computer program stored thereon, the computer program, when executed by a processor, implements a path planning method for a trailer vehicle, the method comprising:
obtaining first position information from a plurality of first points on the tractor to a rear axle center of the tractor, second position information from a plurality of second points on the trailer to the rear axle center of the tractor, a first distance from the rear axle center of the tractor to a center line of a target road, a curvature of the center line of the target road, and a target difference between a heading angle of the trailer and a heading angle of the tractor;
constructing a first projection distance equation and a second projection distance equation, separately, based on at least three of the first position information corresponding to a first target point of the plurality of first points, the first distance, the curvature, the second position information corresponding to a second target point of the plurality of second points, and the target difference, the projection distance equations being used to calculate a projection distance from the first target point and/or the second target point to the center line of the target road; and
obtaining a target path planning result based on the first projection distance equation, the second projection distance equation, and a vehicle path constraint condition.

17. The non-transitory computer-readable storage medium according to claim 16, wherein said constructing the second projection distance equation based on at least three of the first position information corresponding to the first target point of the plurality of first points, the first distance, the curvature, the second position information corresponding to the second target point of the plurality of second points, and the target difference comprises:
determining a third distance between the rear axle center and the target second point and a fourth angle based on the second position information, the fourth angle being an angle determined based on a line connecting the second target point with the rear axle center and a heading direction of the trailer;
determining a second angle based on the heading angle of the tractor and a heading angle of the center line of the target road;
determining a fifth angle based on the fourth angle, the second angle, and the target difference, the fifth angle being an angle determined based on a line connecting a circle center of the center line of the target road with the rear axle center and a line connecting the rear axle center with the second target point; and
processing the first distance, the third distance, the fifth angle, and the curvature based on Law of Cosines to construct the second projection distance equation.

18. The non-transitory computer-readable storage medium according to claim 17, wherein said processing the first distance, the third distance, the fifth angle, and the curvature based on Law of Cosines to construct the second projection distance equation comprises:
constructing the second projection distance equation according to the following equation when the curvature is greater than 0:
$${e}_{{C}_{i , tra}} = - \sqrt{{d}_{i , tra}^{2} + {( {e}_{y} - \frac{1}{{κ}_{r} ( s )} )}^{2} + 2 {d}_{i , tra} ( {e}_{y} - \frac{1}{{κ}_{r} ( s )} ) sin ( {e}_{φ} + β + {θ}_{i , tra} )} + \frac{1}{{κ}_{r} ( s )}$$
where e_{C}_{_{i,tra}} is a second projection distance, d_{i,tra} is the third distance, e_{y} is the first distance, κᵣ(s) is the curvature, θ_{i,tra} is the fourth angle, e_{φ} is the second angle, β is the target difference, and sin(e_{φ}+β+θ_{i,tra}) is obtained by processing the fifth angle based on Law of Cosines, or
constructing the second projection distance equation according to the following equation when the curvature is smaller than 0:
$${e}_{{C}_{i , tra}} = \sqrt{{d}_{i , tra}^{2} + {( {e}_{y} - \frac{1}{{κ}_{r} ( s )} )}^{2} + 2 {d}_{i . tra} ( {e}_{y} - \frac{1}{{κ}_{r} ( s )} ) sin ( {e}_{φ} + β + {θ}_{i , tra} )} + \frac{1}{{κ}_{r} ( s )}$$
where e_{C}_{_{i,tra}} is a second projection distance, d_{i,tra} is the third distance, e_{y} is the first distance, κᵣ(s) is the curvature, θ_{i,tra} is the fourth angle, e_{φ} is the second angle, β is the target difference, and sin(e_{φ}+β+θ_{i,tra}) is obtained by processing the fifth angle based on Law of Cosines.

19. The non-transitory computer-readable storage medium according to claim 16, wherein said obtaining the target path planning result based on the first projection distance equation, the second projection distance equation, and the vehicle path constraint condition comprises:
performing linear processing on the first projection distance equation and the second projection distance equation to obtain a target projection distance equation; and
obtaining the target path planning result based on a target projection distance and the vehicle path constraint condition.

20. The non-transitory computer-readable storage medium according to claim 19, wherein the target projection distance equation comprises:
$${e}_{C} = {ξ}_{{e}_{y}} {e}_{y} + {ξ}_{{e}_{φ}} {e}_{φ} + {ξ}_{β} β + ξ = g ( x )$$
where g(x) and e_{C} are the target projection distance equations, e_{y} is the first distance, e_{φ} is a second angle determined based on the heading angle of the tractor and the heading angle of the center line of the target road, β is the target difference, ξₑ_{_{y}}, ξₑ_{_{φ}}, ξ_{β} and ξ are coefficients obtained by Taylor expansion of the first projection distance equation and the second projection distance equation.
